(19) United States
(12) Patent Application Publication
(10) Pub. No.: US 2018/0096195 A1
(43) Pub. Date: Apr. 5, 2018

(54) PROBABILISTIC FACE DETECTION

(71) Applicant: Microsoft Technology Licensing, LLC, Redmond, WA (US)

(72) Inventors: Cristian Canton Ferrer, Sammamish, WA (US); Stanley T. Birchfield, Sammamish, WA (US); Adam Kirk, Seattle, WA (US); Cha Zhang, Sammamish, WA (US)

(73) Assignee: Microsoft Technology Licensing, LLC, Redmond, WA (US)

(21) Appl. No.: 14/952,447

(22) Filed: Nov. 25, 2015

(51) Int. Cl. G06K 9/00; G06K 9/46; G06K 9/68; G06T 7/20

(52) U.S. Cl. CPC G06K 9/00234; G06T 7/20; G06K 9/6857; G06K 9/4642

(57) ABSTRACT

Examples are disclosed herein that relate to face detection. One example provides a computing device comprising a logic subsystem and a storage subsystem holding instructions executable by the logic subsystem to receive an image, apply a tile array to the image, the tile array comprising a plurality of tiles, and perform face detection on at least a subset of the tiles, where determining whether or not to perform face detection on a given tile is based on a likelihood that the tile includes at least a portion of a human face.

### BACKGROUND

Increasing emphasis has been placed on face detection in the field of computer vision. The computational cost of face detection can be expensive, however, and rises with increasing image size. As image sensor resolution increases, so too does the computational cost of face detection, posing a challenge particularly for mobile devices whose computational resources are limited.

### BRIEF DESCRIPTION OF THE DRAWINGS

FIG. 1 shows an environment in which face detection may be performed on a computing device.

FIG. 2 shows a flow diagram illustrating tile-based face detection.

FIG. 3 schematically shows an example tile hierarchy.

FIG. 4 shows a flowchart illustrating a method of face detection.

FIG. 5 shows a block diagram of a computing device.

### DETAILED DESCRIPTION

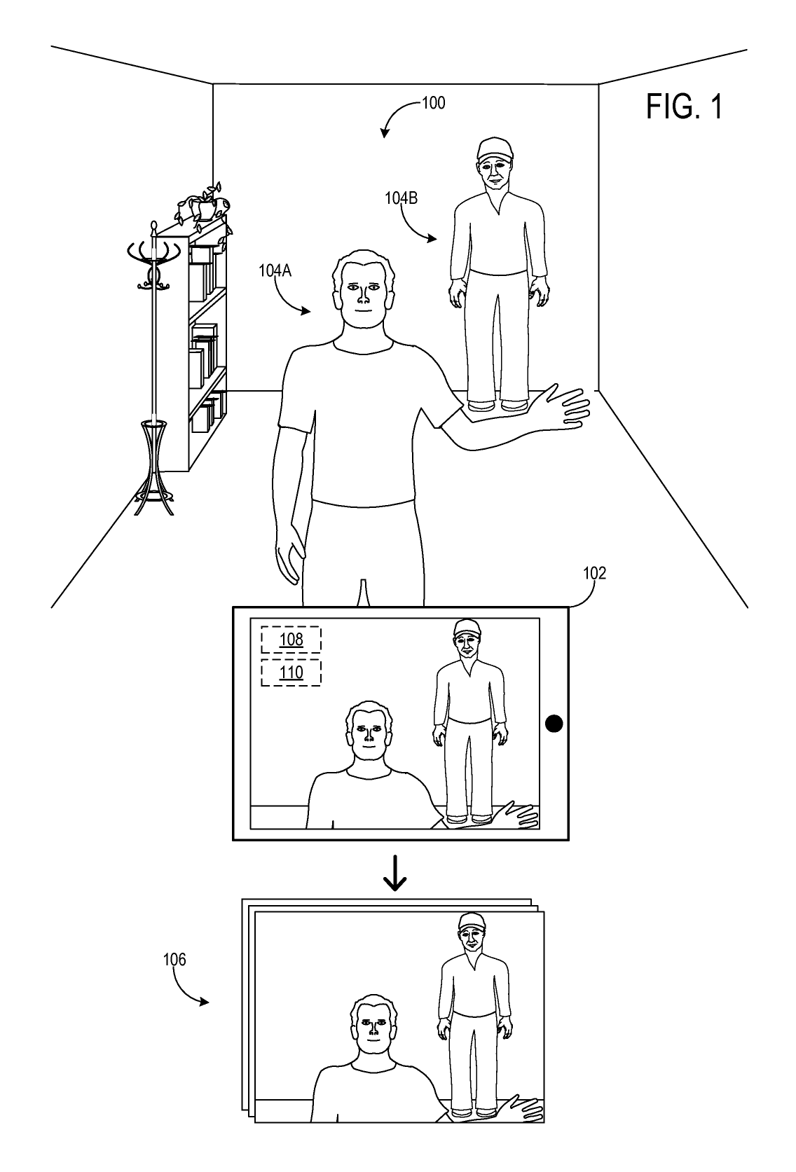

FIG. 1 shows an environment 100 in which face detection may be performed on a computing device 102. Environment 100 is depicted as a home environment, but may assume any suitable form. Using a suitable image sensor, computing device 102 may capture image data that includes portions corresponding to human faces—e.g., the faces of users 104A and 104B occupying environment 100. As such, FIG. 1 illustrates the capture of a set of images 106 that contain image data corresponding to the faces of users 104A and 104B. Computing device 102 may perform face detection on at least part of the image data in the set of images 106, and may take subsequent action based on the results thereof—e.g., red eye, white balance, or other image correction, autofocus, user identification, and permitting or denying access to data based on user identity.

Computing device 102 may capture image data in any suitable form. For example, computing device 102 may be operated in a camera mode, in which case the set of images 106 may be captured as a sequence of images. In another example, computing device 102 may be operated in a video camera mode, in which case the set of images of 106 may be captured as a sequence of frames forming video. In this example, face detection may be performed at a frequency matching that at which video is captured—e.g., 30 or 60 frames per second. Any suitable face detection frequency and image capture method may be used, however.

Although shown as a mobile device, computing device 102 may assume any suitable form, including but not limited to that of a desktop, server, gaming console, tablet computing device, etc. Regardless of the form taken, the set of computational resources (e.g., processing cycles, memory, and bandwidth) available to computing device 102 for performing face detection is limited. The computational resources may be further limited when computing device 102 is configured as a mobile device, due to the limited power available from its power source (e.g., battery). These and other constraints placed on face detection by limited computational resources may force an undesirable tradeoff between face detection and other tasks carried out by computing device 102, which in turn may degrade the user experience—e.g., deemphasizing face detection may render face detection slow and/or inaccurate, while emphasis of face detection may render running applications unresponsive. As such, computing device 102 may be configured to consider the availability of computational resources when determining whether to perform face detection, and may establish a compute budget based on the available resources. Face detection may be limited to subsets, and not the entirety, of image data by performing face detection on regions where human faces are likelier to be found without exceeding the established compute budget.

Computing device 102 may include a logic subsystem 108 and a storage subsystem 110 holding instructions executable by the logic subsystem to effect the approaches described herein. For example, the instructions may be executable to receive an image (e.g., from the set of images 106), apply a tile array to the image, the tile array comprising a plurality of tiles, and perform face detection on at least a subset of the tiles. As described below, one or more of the plurality of tiles may overlap one or more others of the plurality of tiles. Computing device 102 may determine whether or not to perform face detection on a given tile based on a likelihood that the tile includes at least a portion of a human face.

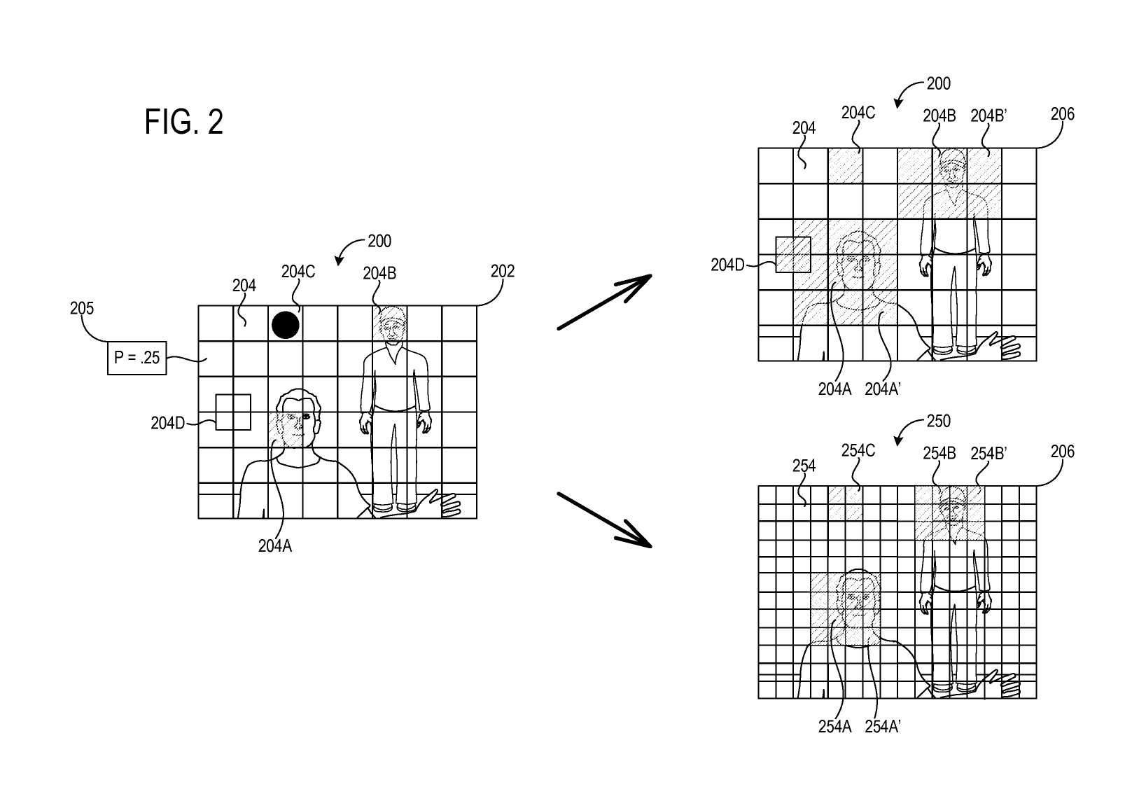

FIG. 2 shows a tile array 200 applied to an image 202, which may be obtained from the set of images 106 of FIG. 1, for example. Tile array 200 includes a plurality of tiles (e.g., tile 204) that are each assigned a likelihood that the corresponding tile includes at least a portion of a human face. With respective likelihoods assigned to each tile 204, face detection may be performed to the extent allowed by an established compute budget. In some example this includes preferentially allocating detection resources to tiles based on how likely the tile is to contain a portion of a human face. In other words, tiles that are more likely to include faces are more likely to be inspected by the example methods herein. An example likelihood 205 is shown assuming the form of a decimal probability, though any suitable representation of likelihood may be employed.

In view of the above, “face detection” as used herein may refer to the detection of a complete face or a portion, and not the entirety, thereof. For example, in some implementations face detection performed in a tile may produce positive results (i.e., detection of a face portion therein) if a sufficient face portion resides in the tile, without requiring that the entirety of the face resides in the tile to prompt positive face detection. The approaches disclosed herein, however, are equally applicable to implementations that do require the entirety, and not merely portions, of a face to reside in a tile for face detection to produce positive results in the tile. Further, in such implementations that do require complete faces to yield positive face detection, only tiles of scales suited to the size of a face in an image (e.g., large enough to completely contain the face without containing significant image portions that do not correspond to the face) may yield positive detection of the face, while tiles of scales unsuited to the size of the face (e.g., of scales that contain only portions, and not the entirety, of the face, or of scales that contain significant image portions that do not correspond to the face) may not yield positive detection of the face. Details regarding tile scale are discussed below.

The likelihoods for each tile 204 in tile array 200 may be determined based on any practicable criteria, and in many examples it will be desirable to establish likelihood with a focus on making efficient use of compute resources. Further, in most examples the likelihood determination will be performed via mechanisms that are significantly less computationally expensive than the actual face detection methods used on the tiles. As a non-limiting example, the likelihoods may be determined based at least on pixel color. For pixel color, the colors of one or more pixels in a given tile (e.g., an average color of two or more pixels) may be compared to colors that correspond to human skin, with a greater correspondence between pixel color and human skin color leading to assignment of a greater likelihood, and lesser correspondence leading to assignment of a lesser likelihood.

Other criteria may be used in determining tile likelihoods. For example, an assessment of tiles in a frame in a sequence of video frames may be used in assigning likelihoods in subsequent frames. FIG. 2 shows, in image 202, two tiles 204A and 204B for which high likelihoods are determined. After assigning likelihoods to each tile 204 in tile array 200, tiles are selected for inspection based on likelihood. In this example, due to their high likelihoods, tiles 204A and 204B are inspected with positive results. FIG. 2 further shows an image 206 captured subsequent to image 202—e.g., image 206 may be the next frame following image 202 in a sequence of video frames. Tile array 200 may be applied to image 206, with likelihoods assigned to each tile 204 in the tile array. Here, the faces detected in image 202 may be considered in assigning likelihoods to tiles for image 206—the high likelihoods assigned to tiles 204A and 204B in assessing image 202 may be retained or increased, for example.

In some examples, a maximum likelihood (e.g., 0.99) may be assigned to tiles 204A and 204B (e.g., based on positive face detection). When assigned to a tile, the maximum likelihood may ensure that face detection is performed on the tile; in this case whether face detection is performed on a tile may be controlled by performing face detection on tiles having probabilities greater than a threshold (e.g., a threshold specified by an established compute budget). From this example, it will be appreciated that mechanisms may be employed to guarantee that a given tile is inspected. In alternate methods, however, resource constraints or other considerations may lead to a scheme in which there is no such guarantee, but rather only a proportionately high possibility of a tile being selected for inspection.

The detection of a face in a tile may influence the likelihood assignment to other tiles. FIG. 2 shows the assignment of the maximum likelihood to tiles respectively spatially adjacent to tiles 204A and 204B (e.g., tile 204A′ and tile 204B′, respectively) as a result of positive face detection in tiles 204A and 204B. The adjacent tiles 204A′ and 204B′, as applied to image 206, may also be considered temporally adjacent to tiles 204 as applied to image 202 due to the potential temporal proximity of image 202 to image 206. The retention or increase of high likelihoods in tiles 204A and 204B from image 202 to image 206, and the propagation of high likelihoods to adjacent tiles 204A′ and 204B′, represent examples of basing tile likelihood determination on prior face detection. In particular, the spatial and/or temporal propagation of high likelihoods among tiles may enable face detection to be performed on moving human subjects such that those human subjects can be persistently tracked throughout a sequence of video frames, despite lacking knowledge of the speed and direction of their movement.

The propagation of likelihoods among tiles may be implemented in a variety of suitable manners. Although the propagation of the maximum likelihood from tiles 204A and 204B to respectively adjacent tiles 204A′ and 204B′ is described above, non-maximum likelihoods may alternatively be propagated. In some configurations, non-maximum likelihoods may not ensure the performance of face detection. As a more particular example, the propagation of likelihoods may be a function of tile distance—e.g., a first tile to which a likelihood is propagated from a second tile may receive a likelihood that is reduced relative to the likelihood assigned to the second tile, in proportion to the distance between the first and second tiles.

In some implementations, facial part classification may be employed in assigning and/or propagating likelihoods. For example, tiles corresponding to face parts relatively more invariant to transformations (e.g., rotation), such as the nose and mouth, may be assigned greater likelihoods relative to other face parts that more frequently become occluded or otherwise obscured due to such transformations. When used in combination with motion, described below, facial part classification may lead to the assignment of greater likelihoods to tiles adjacent to the more invariant face parts, in contrast to the assignment of lesser likelihoods to tiles adjacent to the less invariant face parts. Such an approach may represent an expectation that face portions closer to the center of a face will have a greater persistence in images when the face is in motion.

A tile array may include at least one tile that overlaps another tile. FIG. 2 shows a tile 204D overlapping several underlying tiles 204, which may be one of a plurality of overlapping tiles (e.g., some of a plurality of tiles may at least partially overlap others of the plurality of tiles). In the depicted example, tile 204D is the size of the other tiles, though tile arrays having tiles of smaller and larger scales may be employed, as explained below. Overlapping tiles may be positioned in any suitable arrangement, and may increase the robustness of face detection by mitigating the occupancy of non-overlapping tiles by portions, and not the entirety, of faces. Further, overlapping tiles may be used in propagating likelihoods in the manners described above. FIG. 2 shows the assignment of a high likelihood to overlapping tile 204D, as applied to image 206, as a result of its overlap with (e.g., and adjacency to) two tiles 204 to which high likelihoods were assigned. Alternatively or in addition to the propagation of likelihoods to overlapping tiles, likelihoods may be propagated to underlying tiles—e.g., from overlapping tile 204D to underlying tiles 204. Generally, a tile may be considered adjacent to the tiles with which it overlaps.

Likelihood determination may be based on motion. In one example, a change in the color (e.g., average pixel color) of corresponding tiles between frames may be considered an indication of motion. FIG. 2 shows a tile 204C as applied to image 202 having a first color as a result of the tile's occupancy by an object. In image 206, however, the object no longer occupies tile 204C, which consequently assumes a different color. As such, tile 204C as applied to image 206 is assigned a high (e.g., maximum) likelihood. The use of motion may alternatively or additionally be pixel-based; high likelihoods may be assigned to one or more (e.g., all) tiles that include a pixel determined to have undergone motion.

Likelihood propagation may account for the speed and direction of motion. A motion vector, for example, may be computed based on observed rates of change in pixel color and the directions along which similar changes in pixel color propagate. The likelihood of a tile where motion originated may be propagated to tiles substantially on the path of the motion vector—e.g., intersecting or adjacent to the motion vector or an extension thereof. Further, likelihoods may be propagated to tiles of increasing distance from a tile where motion originated as the speed of motion (e.g., vector magnitude) increases—e.g., a relatively low speed of motion may lead to likelihood propagation to only immediately adjacent tiles, whereas a relatively higher speed of motion may lead to likelihood propagation to tiles beyond those that are immediately adjacent. In an alternative implementation, a likelihood propagated to other tiles may be scaled down as a function of distance, where the degree of scaling is less for higher speeds of motion and greater for lower speeds of motion.

Likelihood determination may be based on environmental priors. For example, a computing device (e.g., computing device 102 of FIG. 1) may learn locations in images where faces are likelier to be found over time—e.g., in the course of assessing thousands of images containing various positive detections in a range of locations. When assessing images after learning these locations, tiles corresponding to these locations may be identified and high likelihoods assigned thereto without performing other assessments of likelihood. Similarly, locations where faces are less likely to be found—or where faces have never been found—may be identified and tiles corresponding to these locations assigned low likelihoods without performing other assessments of likelihood. The use of environmental priors in this way may guide face detection to likely locations of faces without expending significant computational resources. Further, an existing environmental prior may be updated over time—e.g., locations previously deemed likely to include faces may be assigned increasingly lower likelihoods as face detection continually fails to find faces therein. Generally, environmental priors may be learned and/or used across temporally proximate frames (e.g., from the same video stream) and for non-temporally proximate frames—for example, an environmental prior learned for a first video stream may be used in assigning likelihoods for a second different video stream that is not temporally proximate to the first stream. User input, or a determination based on image data, may indicate whether an existing environmental prior is applicable to an environment being imaged, for example. Still further, object classification may be employed to recognize the nature and type of objects in an environment—for example, locations proximate to recognized chairs and other furniture may be considered likely to include faces, whereas the extremities of a room (e.g., ceiling, floor) may be considered unlikely to include faces.

Likelihood determination may consider both environmental priors and motion, which may be weighted differently. For example, in lieu of assigning to a tile a moderate likelihood (e.g., 0.50) determined based only on moderate motion in that tile, a relatively greater likelihood may be assigned to the tile as a result of an environmental prior indicating that tile to be a likely location where faces may be found. As another example, a likelihood determined based only on motion for a tile may be reduced if an environmental prior indicates that tile to be at a location where faces are not likely to be found. In some examples, indications of large motion may lead to the assignment of high (e.g., the maximum) likelihoods to a tile, even if an environmental prior indicates that tile to be an unlikely face location. Generally, two or more of the criteria described herein may be considered in assigning likelihoods.

In some examples, the computing device may accept user input for establishing prior likelihoods—for example, the user input may be operable to identify locations (e.g., tiles) where the presence of faces are physically impossible, for example, such that face detection is not performed at these locations (e.g., by assigning corresponding tiles likelihoods of zero). User input may alternatively or additionally be used to assign any suitable likelihood to image locations.

In some implementations, two or more tile arrays at different scales may be used to effect the approaches described herein. “Scale” as used herein may refer to the size of tiles in a given tile array, and a collection of tile arrays at different scales may be referred to as a tile “hierarchy”. FIG. 2 shows a tile array 250 at a scale different from the scale of tile array 200 applied to image 206. As non-limiting examples, the scale of tile array 200 may be 64×64 (e.g., each tile is 64×64 pixels), while the scale of tile array 250 may be 32×32. Tile arrays 200 and 250 may thus together form a tile hierarchy. While two tile scales are depicted in FIG. 2, any suitable number of scales may be used, and may be selected based on the expected size of faces and the degree of motion they may potentially undergo; for example, a tile hierarchy including tile scales from 30×30 pixels to 500×500 pixels may be selected.

Tile array 250 includes a plurality of tiles (e.g., tile 254) that are each assigned a likelihood that the corresponding tile includes at least a portion of a human face based on one or more of the criteria described above. Similar to the application of tile array 200 to image 206, tiles 254 may be assigned likelihoods based on the outcome of assessing image 202; FIG. 2 shows the assignment of high likelihoods to tiles (e.g., tiles 254A and 254B) that spatially correspond to tiles 204A and 204B, respectively, as well as the assignment of high likelihoods to tiles (e.g., tiles 254A′ and 254B′) respectively adjacent to tiles 254A and 254B. In some examples, the assessment of image 206 using tiles at the first and second scales respectively provided by tile arrays 200 and 250 may occur substantially simultaneously. By applying different tile scales to a common image, the robustness of face detection may be increased, as some tile scales may be excessively small or large for faces at a given distance. The use of different tile scales may further enable persistent tracking of users in motion—for example, a user may rapidly move toward or away from a camera, potentially changing the tile scale that is most suited for the detection of that user's face; this change in scale may be adapted to by exploring tiles at different scales for a common image.

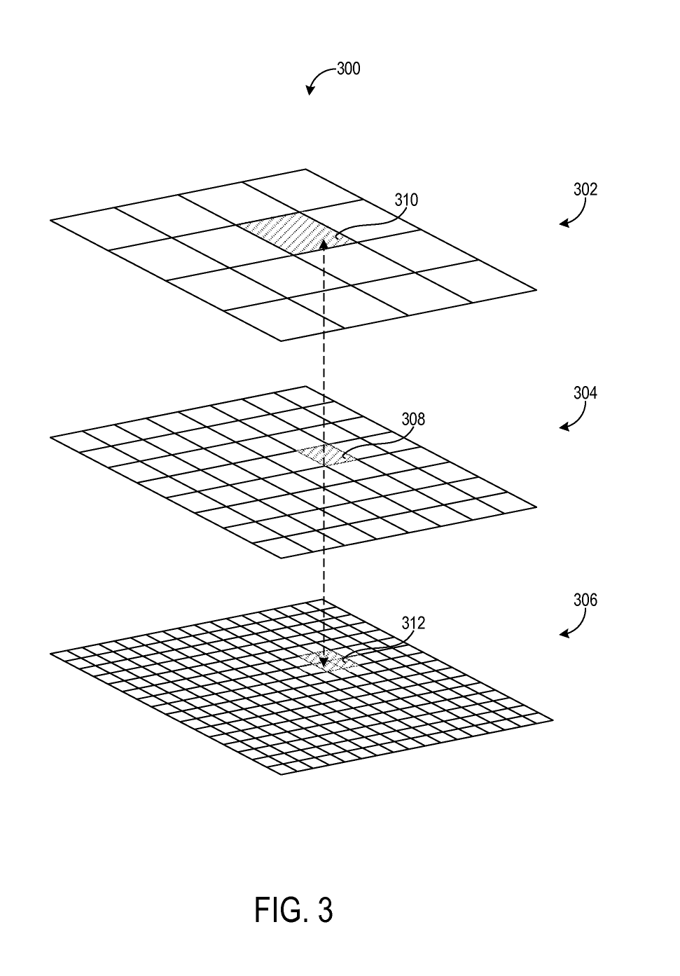

Although not illustrated in FIG. 2, tile arrays 200 and 250 may overlap, such that at least one tile of a first scale may overlap at least one tile of a second scale. Accordingly, the propagation of likelihoods based on tile overlap described above may be implemented across tile arrays of different scales. FIG. 3 shows an example tile hierarchy 300 comprising a first tile array 302 at a first scale (e.g., 32×32), a second tile array 304 at a second scale (e.g., 64×64), and third tile array 306 at a second scale (e.g., 128×128). In this example, a likelihood assigned to a tile 308 of second tile array 304 is propagated to spatially corresponding tiles of the first and third tile arrays 302 and 306—particularly, to tile 310 at the first scale, which overlaps tile 308, and to four tiles (e.g., tile 312) at the third scale overlapped by tile 308. The propagation of likelihoods from second tile array 304 to first and third tile arrays 302 and 306 may occur for the same frame, or may occur in a frame subsequent to a frame for which only the first tile array is used. Although the example depicted in FIG. 3 shows the exploration of scales immediately adjacent to the second scale in both directions (e.g., larger and smaller), exploration of scales in only one direction is possible, as is exploration of a scale not immediately adjacent to a current scale undergoing exploration as described below. FIG. 3 shows how a tile hierarchy incorporating a plurality of tile arrays at a plurality of different scales may include a plurality of overlapping tiles at different scales. Different types of overlap are possible, including aligned and non-aligned configurations. Generally, a tile hierarchy may include any suitable number of tile arrays, of any suitable scales (e.g., including two or more arrays at the same scale), with any suitable arrangement.

The selection of tile scales may be based on motion. For example, the transition between tile scales may be controlled in proportion to a magnitude of detected or expected motion; if a relatively large degree of motion is believed to be occurring, a transition from a tile array of scale Y to a tile array of scale Y+/−2 may be effected, rather than to a tile array of scale Y+/−1 (e.g., an adjacent tile scale). Such an approach may allow a detected face to be persistently tracked in the event the face rapidly moves toward or away from a camera, for example. Generally, any suitable adjacent or non-adjacent transition between tile scales may occur, including a transition from a smallest to largest tile scale and vice versa.

In the course of using a tile hierarchy, determining whether to perform face detection on a tile may be based on a scale of the tile. For example, face detection may be preferentially performed for tiles of a relatively larger scale than tiles of a relatively smaller scale—e.g., tiles 204 of tile array 200 may be preferentially assessed over tiles 254 of tile array 250 due to the relatively greater scale of tile array 200. Such an approach may reduce computational cost, at least initially, as in some examples the cost of performing face detection may not scale linearly with tile scale—for example, the cost associated with tiles of scale 32×32 may not be reduced relative to the cost associated with tiles of scale 64×64 in proportion to the reduction in tile size when going from 64×64 to 32×32. The preferential exploration of tiles at relatively greater scales may increase the speed at which faces relatively close to a camera are detected, while slightly delaying the detection of faces relatively distanced from the camera. It will be understood that, in some examples, the preferential exploration of relatively larger tiles may be a consequence of larger tiles generally having greater likelihoods of containing a face due to the greater image portions they cover, and not a result of an explicit setting causing such preferential exploration. Implementations are possible, however, in which an explicit setting may be established that causes preferential exploration of larger scales over smaller scales, smaller or medium-sized scales over larger scales, etc. For example, a set of scales (e.g., smaller scales) may be preferentially explored over a different set of scales (e.g., larger scales) based on an expected face distance, which may establish a range of expected face sizes in image-space on which exploration may be focused.

As described above, the approaches described herein for performing face detection based on tile likelihoods may be carried out based on an established compute budget. The compute budget may be established based on available (e.g., unallocated) computing resources and/or other potential factors such as application context (e.g., a relatively demanding application may force a reduced compute budget to maintain a desired user experience). The compute budget, in some scenarios, may limit the performance of face detection to a subset, but not all of, the tiles in a tile array or tile hierarchy. The subset of tiles that are evaluated for the presence of faces may be selected on the basis of likelihood such that tiles of greater likelihood are evaluated before tiles of relatively lesser likelihood.

An established compute budget may constrain face detection in various manners. For example, the compute budget may constrain a subset of tiles on which face detection is performed in size—e.g., the budget may stipulate a number of tiles that can be evaluated without exceeding the compute budget. As another example, the compute budget may stipulate a length of time in which tiles can be evaluated. Regardless of its configuration, face detection may be performed on a subset of tiles until the compute budget is exhausted. In some examples, face detection may be performed on at least a subset of tiles, followed by the performance of face detection on additional tiles until the compute budget is exhausted. In this scenario, the compute budget may have constrained face detection to the subset of tiles, but, upon completion of face detection on the subset, the compute budget is not fully exhausted. As such, face detection may be performed on additional tiles until the compute budget is exhausted. In other examples, the compute budget may be re-determined upon its exhaustion, which may prompt the evaluation of additional tiles. Establishment of the compute budget may be performed in any suitable manner and at any suitable frequency; the compute budget may be established for every frame/image, at two or more times within a given frame/image, for each sequence of contiguous video frames, etc. Consequently, the number of tiles on which face detection is performed may vary from frame/image to frame/image for at least some of a plurality of received frames/images. Such variation may be based on variations in the established compute budget (e.g., established for each frame/image). Thus, a compute budget may be dynamically established. It will nevertheless be understood, however, that in some scenarios a common compute budget established for different frames may lead to face detection in different numbers of tiles across the frames. Further, the variation in the number of tiles on which face detection is performed may be a function of other factors alternative or in addition to a varying compute budget, including but not limited to randomness and/or image data (e.g., variation in the number of faces in different images).

Non-zero likelihoods may be assigned to every tile in a given tile array or tile hierarchy. For example, a minimum but non-zero likelihood (e.g., 0.01) may be assigned to tiles for which their evaluations suggested no presence of a face. The assignment of non-zero likelihoods to every tile—even for tiles in which the presence of a face is not detected or expected—enables their eventual evaluation so that no tile goes unexplored over the long term. Although the approaches described herein may preferentially evaluate likelier tiles, the tile selection process may employ some degree of randomness so that minimum likelihood tiles are explored and all regions of an image eventually assessed for the presence of faces. The assignment of non-zero likelihoods may be one example of a variety of approaches that enable the modification of tile likelihood relative to the likelihood that would otherwise be determined without such modification—e.g., based on one or more of the criteria described herein such as pixel color, motion, environmental priors, and previous face detections. A tile's likelihood may be modified to achieve a desired frequency with which face detection is performed therein, for example. In some implementations, a likelihood modification may be weighted less relative to the likelihood determined based on a criterion-based assessment. In this way, the modification may be limited to effecting small changes in likelihood.

The process by which tiles are selected for face detection may be implemented in various suitable manners. In one example, each tile may be assigned a probability—e.g., likelihood 205. A random number (e.g., a decimal probability) may be generated and compared, for a given tile, to that tile's probability to determine whether or not to perform face detection in the tile. If the tile's probability exceeds the random number, the tile may be designated for face detection, whereas the tile may not be designated for face detection if the tile's probability falls below the random number. A random number may be generated for each image so that the probability of performing face detection on a region of an image in N frames can be determined.

As another non-limiting example, probabilistic face detection may be implemented using what is referred to herein as a “token” based approach. In this example, a number of unique tokens (e.g., alphanumeric identifiers) may be assigned to each tile. The number of unique tokens assigned to a given tile may be in direct proportion to the likelihood associated with that tile, such that likelier tiles are assigned greater numbers of tokens. The collection of unique tokens assigned to all tiles may form a token pool. A number of unique tokens may then be randomly selected from the token pool. This number of tokens selected from the token pool may be stipulated by an established compute budget, for example. Each tile corresponding to each selected token may then be designated for face detection. Such an approach enables probabilistic tile selection in which likelier tiles are naturally selected by virtue of their greater number of assigned tokens.

The approaches herein to tile-based face detection may be modified in various suitable manners. For example, the propagation of likelihoods to spatially adjacent tiles in a subsequent frame may also occur for spatially adjacent tiles in the same frame. In this example, face detection may be performed at multiple stages for a single image. Further, the propagation of likelihoods may be carried out in any suitable manner—e.g., the same likelihood may be propagated between tiles, or may be modified, such as by being slightly reduced as described above. Still further, entire images or frames may be evaluated for the likelihood of including a face; those images/frames considered unlikely to include a face may be discarded from face detection. Yet further, any suitable face detection methods may be employed with the approaches described herein. An example face detection method may include, for example, feature extraction, feature vector formation, and feature vector distance determination.

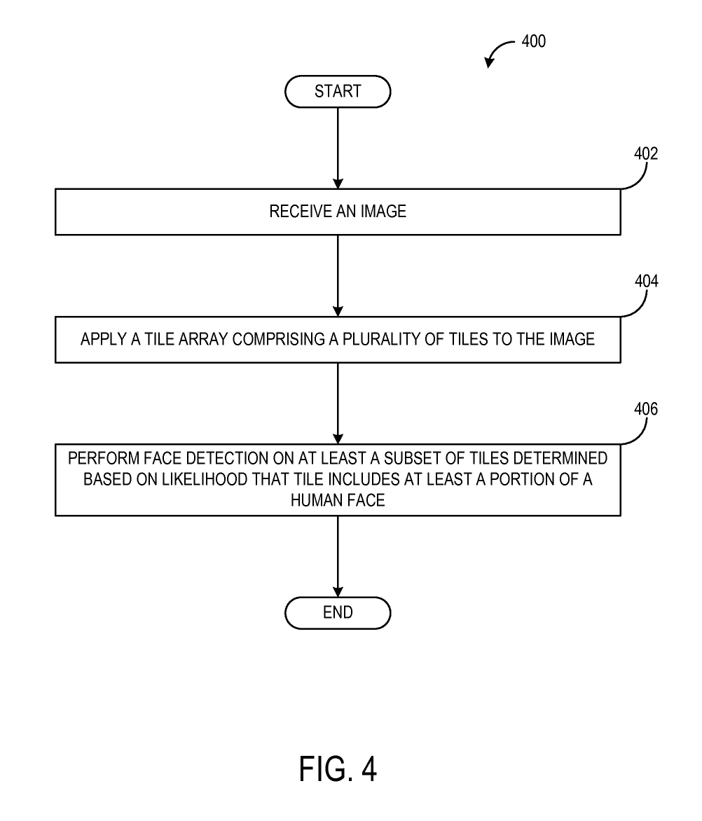

FIG. 4 shows a flowchart illustrating a method 400 of face detection. Method 400 may be stored as instructions held by storage subsystem 110 and executable by logic subsystem 108, both of computing device 102 of FIG. 1, for example.

At 402, method 400 may include receiving an image.

At 404, method 400 may include applying a tile array to the image. The tile array may comprise a plurality of tiles.

At 406, method 400 may include performing face detection on at least a subset of the tiles. Determining whether or not to perform face detection on a given tile may be based on a likelihood that the tile includes at least a portion of a human face. The subset of the tiles on which face detection is performed may be constrained in size by a compute budget. The subset of tiles may include at least one tile at a first scale and at least one tile at a second scale different from the first scale. At least one of the subset of tiles may at least partially overlap another one of the subset of tiles.

Method 400 may further comprise, for each tile in which at least a portion of a human face is detected, performing face detection on one or more respectively adjacent tiles. The one or more respectively adjacent tiles may be spatially and/or temporally adjacent.

In some embodiments, the methods and processes described herein may be tied to a computing system of one or more computing devices. In particular, such methods and processes may be implemented as a computer-application program or service, an application-programming interface (API), a library, and/or other computer-program product.

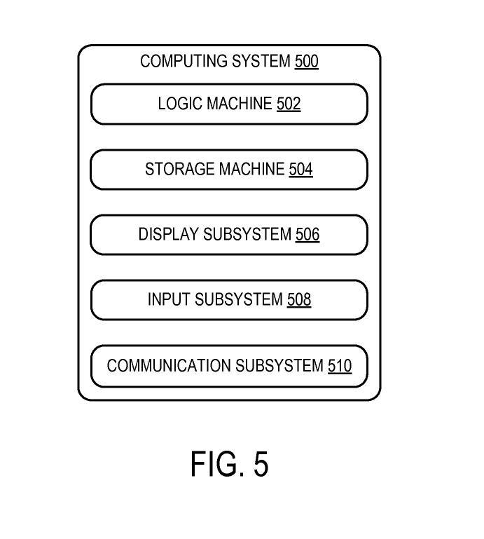

FIG. 5 schematically shows a non-limiting embodiment of a computing system 500 that can enact one or more of the methods and processes described above. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phone), and/or other computing devices.

Computing system 500 includes a logic machine 502 and a storage machine 504. Computing system 500 may optionally include a display subsystem 506, input subsystem 508, communication subsystem 510, and/or other components not shown in FIG. 5.

Logic machine 502 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 504 includes one or more physical devices configured to hold instructions executable by the logic machine to implement the methods and processes described herein. When such methods and processes are implemented, the state of storage machine 504 may be transformed—e.g., to hold different data.

Storage machine 504 may include removable and/or built-in devices. Storage machine 504 may include optical memory (e.g., CD, DVD, HD-DVD, and Blu-Ray Disc), semiconductor memory (e.g., RAM, EPROM, and EEPROM), and/or magnetic memory (e.g., hard-disk drive, floppy-disk drive, tape drive, and MRAM), among others. Storage machine 504 may include volatile, nonvolatile, dynamic, static, read/write, read-only, random-access, sequential-access, location-addressable, file-addressable, and/or content-addressable devices.

It will be appreciated that storage machine 504 includes one or more physical devices. However, aspects of the instructions described herein alternatively may be propagated by a communication medium (e.g., an electromagnetic signal or an optical signal) that is not held by a physical device for a finite duration.

Aspects of logic machine 502 and storage machine 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 implemented to perform a particular function. In some cases, a module, program, or engine may be instantiated via logic machine 502 executing instructions held by storage machine 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 506 may be used to present a visual representation of data held by storage machine 504. This visual representation may take the form of a graphical user interface (GUI). As the herein described methods and processes change the data held by the storage machine, and thus transform the state of the storage machine, the state of display subsystem 506 may likewise be transformed to visually represent changes in the underlying data. Display subsystem 506 may include one or more display devices utilizing virtually any type of technology. Such display devices may be combined with logic machine 502 and/or storage machine 504 in a shared enclosure, or such display devices may be peripheral display devices.

When included, input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the Internet.

An example provides a computing device comprising a logic subsystem and a storage subsystem holding instructions executable by the logic subsystem to receive an image, apply a tile array to the image, the tile array comprising a plurality of tiles, and perform face detection on at least a subset of the tiles, where determining whether or not to perform face detection on a given tile is based on a likelihood that the tile includes at least a portion of a human face. In such an example, the subset of the tiles on which face detection is performed alternatively or additionally may be constrained in size by a compute budget. In such an example, the instructions alternatively or additionally may be further executable to, after performing face detection on at least the subset of the tiles, perform face detection on additional tiles until a compute budget is exhausted. In such an example, the instructions alternatively or additionally may be executable for a plurality of received images, and a number of tiles on which face detection is performed alternatively or additionally may vary from image to image for at least some of the plurality of received images, such variation being based on variations in a compute budget. In such an example, the instructions alternatively or additionally may be further executable to, for each tile in which at least a portion of a human face is detected, perform face detection on one or more respectively adjacent tiles in response to such detection. In such an example, the tile array alternatively or additionally may be a first tile array comprising a first plurality of tiles at a first scale, the first tile array belonging to a tile hierarchy comprising a plurality of tile arrays including a second tile array comprising a second plurality of tiles at a second scale, and the subset of the tiles alternatively or additionally may include a first subset of the first plurality of tiles and a second subset of the second plurality of tiles. In such an example, the second subset of the second plurality of tiles alternatively or additionally may spatially correspond to the first subset of the first plurality of tiles. In such an example, some of the plurality of tiles alternatively or additionally may at least partially overlap others of the plurality of tiles. In such an example, the likelihood alternatively or additionally may be determined based on prior face detection. In such an example, the likelihood alternatively or additionally may be determined based on motion. In such an example, the likelihood alternatively or additionally may be determined based on one or both of pixel color and an environmental prior. In such an example, each likelihood alternatively or additionally may be non-zero. In such an example, determining whether or not to perform face detection on the given tile alternatively or additionally may be further based on a scale of the given tile, such that face detection is preferentially performed for tiles of a first scale than tiles of a second scale. Any or all of the above-described examples may be combined in any suitable manner in various implementations.

Another example provides a face detection method comprising receiving an image, applying a tile array to the image, the tile array comprising a plurality of tiles, and performing face detection on at least a subset of the tiles, where determining whether or not to perform face detection on a given tile is based on a likelihood that the tile includes at least a portion of a human face. In such an example, the subset of the tiles on which face detection is performed alternatively or additionally may be constrained in size by a compute budget. In such an example, the method alternatively or additionally may comprise, for each tile in which at least a portion of a human face is detected, performing face detection on one or more respectively adjacent tiles. In such an example, the one or more respectively adjacent tiles alternatively or additionally may be spatially and/or temporally adjacent. In such an example, the subset of tiles alternatively or additionally may include at least one tile at a first scale and at least one tile at a second scale different from the first scale. In such an example, at least one of the subset of tiles alternatively or additionally may at least partially overlap another one of the subset of tiles. Any or all of the above-described examples may be combined in any suitable manner in various implementations.

Another example provides a face detection method, comprising receiving an image, applying a tile array to the image, the tile array comprising a plurality of tiles, establishing a compute budget, and performing face detection on some, but not all, of the tiles until the compute budget is exhausted, where determining whether or not to perform face detection on a given tile is based on a likelihood that the tile includes at least a portion of a human face. Any or all of the above-described examples may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a logic subsystem; and
a storage subsystem holding instructions executable by the logic subsystem to:
receive an image;
apply a tile array to the image, the tile array comprising a plurality of tiles; and
perform face detection on at least a subset of the tiles, where determining whether or not to perform face detection on a given tile is based on a likelihood that the tile includes at least a portion of a human face.

2. The device of claim 1, where the subset of the tiles on which face detection is performed is constrained in size by a compute budget.

3. The device of claim 1, where the instructions are further executable to, after performing face detection on at least the subset of the tiles, perform face detection on additional tiles until a compute budget is exhausted.

4. The device of claim 1, where the instructions are executable for a plurality of received images, and
where a number of tiles on which face detection is performed varies from image to image for at least some of the plurality of received images, such variation being based on variations in a compute budget.

5. The device of claim 1, where the instructions are further executable to, for each tile in which at least a portion of a human face is detected, perform face detection on one or more respectively adjacent tiles in response to such detection.

6. The device of claim 1, where the tile array is a first tile array comprising a first plurality of tiles at a first scale, the first tile array belonging to a tile hierarchy comprising a plurality of tile arrays including a second tile array comprising a second plurality of tiles at a second scale, and where the subset of the tiles includes a first subset of the first plurality of tiles and a second subset of the second plurality of tiles.

7. The device of claim 6, where the second subset of the second plurality of tiles spatially corresponds to the first subset of the first plurality of tiles.

8. The device of claim 1, where some of the plurality of tiles at least partially overlap others of the plurality of tiles.

9. The device of claim 1, where the likelihood is determined based on prior face detection.

10. The device of claim 1, where the likelihood is determined based on motion.

11. The device of claim 1, where the likelihood is determined based on one or both of pixel color and an environmental prior.

12. The device of claim 1, where each likelihood is non-zero.

13. The device of claim 1, where determining whether or not to perform face detection on the given tile is further based on a scale of the given tile, such that face detection is preferentially performed for tiles of a first scale than tiles of a second scale.

14. A face detection method, comprising:
receiving an image;
applying a tile array to the image, the tile array comprising a plurality of tiles; and
performing face detection on at least a subset of the tiles, where determining whether or not to perform face detection on a given tile is based on a likelihood that the tile includes at least a portion of a human face.

15. The method of claim 14, where the subset of the tiles on which face detection is performed is constrained in size by a compute budget.

16. The method of claim 14, further comprising, for each tile in which at least a portion of a human face is detected, performing face detection on one or more respectively adjacent tiles.

17. The method of claim 16, where the one or more respectively adjacent tiles are spatially and/or temporally adjacent.

18. The method of claim 14, where the subset of tiles includes at least one tile at a first scale and at least one tile at a second scale different from the first scale.

19. The method of claim 14, where at least one of the subset of tiles at least partially overlaps another one of the subset of tiles.

20. A face detection method, comprising:
receiving an image;
applying a tile array to the image, the tile array comprising a plurality of tiles;
establishing a compute budget; and
performing face detection on some, but not all, of the tiles until the compute budget is exhausted, where determining whether or not to perform face detection on a given tile is based on a likelihood that the tile includes at least a portion of a human face.
